(19) United States
(12) Patent Application Publication
(10) Pub. No.: US 2025/0264844 A1
(43) Pub. Date: Aug. 21, 2025

(54) APPARATUS AND METHOD FOR CALCULATING HOMOGRAPHY OF FOURIER PROPAGATION STRUCTURE

(71) Applicant: ELECTRONICS AND TELECOMMUNICATIONS RESEARCH INSTITUTE, Daejeon (KR)

(72) Inventor: Han-Ju YEOM, Sejong-si (KR)

(73) Assignee: ELECTRONICS AND TELECOMMUNICATIONS RESEARCH INSTITUTE, Daejeon (KR)

(21) Appl. No.: 19/046,006

(22) Filed: Feb. 5, 2025

(30) Foreign Application Priority Data
Feb. 21, 2024 (KR) 10-2024-0025107

(51) Int. Cl. G03H 1/04; G03H 1/22

(52) U.S. Cl. CPC G03H 1/0443; G03H 1/2205; G03H 2001/045; G03H 2227/02

(57) ABSTRACT

Disclosed herein are an apparatus and method for calculating homography of a Fourier propagation structure. The method for calculating homography of a Fourier propagation structure includes generating a point array image, inserting a certain frame into an edge of the point array image, generating a phase hologram based on the point array image, perform optical restoration and camera capturing on the phase hologram, extracting a point array from each of an optically restored image and a camera-captured image, and calculating homography based on the extracted point array.

### CROSS REFERENCE TO RELATED APPLICATION

This application claims the benefit of Korean Patent Application No. 10-2024-0025107, filed Feb. 21, 2024, which is hereby incorporated by reference in its entirety into this application.

### BACKGROUND OF THE INVENTION

### 1. Technical Field

The following embodiments relate to technology for camera-in-the-loop (CITL)-based hologram optimization in a Fourier propagation structure.

### 2. Description of the Related Art

A digital hologram (e.g., Computer Generated Hologram: CGH) is a complex plane composed of amplitude and phase, but a Spatial Light Modulator (SLM) that is a display used for optical restoration can modulate only the phase. Therefore, even if a complex hologram is accurately calculated, noise inevitably occurs because amplitude is not used in optical restoration.

Among various methods for overcoming the occurrence of noise, prior art document 1 (Yifan Peng, Suyeon Choi, Nitish Padmanaban, and Gordon Wetzstein. 2020. Neural holography with camera-in-the-loop training. ACM Trans. Graph. 39, 6, Article 185 (December 2020), 14 pages, https://doi.org/10.1145/3414685.3417802) proposes a Stochastic Gradient Descent (SGD)-based phase hologram optimization method having better performance than conventional methods.

However, even an SGD-based phase hologram that is numerically accurately calculated is observed in a form including a lot of noise in optical restoration. This is due to the fact that an optical restoration system is non-ideal unlike numerical calculation.

Examples of such non-ideal factors may include the non-uniformity of an input light source, quantization modulation level errors of SLM, physical defects in SLM pixels, lens distortion, aberrations, etc.

In order to reduce noise occurring due to those problems, prior art document 1 proposes a method for removing noise even in optical restoration through camera-in-the-loop (CITL)-based phase hologram optimization which applies an image acquired by a camera to SGD-based phase hologram optimization.

A CITL-based phase hologram optimization system is technology that is capable of remarkably reducing noise occurring in optical restoration. There is a need to perform mapping between the image captured by the camera for CITL and an image calculated through numerical restoration, and homography required for mapping needs to be calculated before CITL is performed.

### SUMMARY OF THE INVENTION

An embodiment is intended to calculate homography required for mapping so as to optimize a camera-in-the-loop (CITL)-based hologram in a Fourier propagation structure.

In accordance with an aspect, there is provided a method for calculating homography of a Fourier propagation structure, including generating a point array image, inserting a certain frame into an edge of the point array image, generating a phase hologram based on the point array image, perform optical restoration and camera capturing on the phase hologram, extracting a point array from each of an optically restored image and a camera-captured image, and calculating homography based on the extracted point array.

Generating the phase hologram may include generating the phase hologram in a partial region of a total area represented by Fourier propagation.

The method may further include removing a region in which interference occurs from the certain frame.

The method may further include linearly correcting brightness of the point array image.

Linearly correcting the brightness may include generating a scaling factor image having a value within a preset range, and multiplying the point array image by the generated scaling factor image.

The value within the preset range may be a value ranging from ‘0’ to ‘1’.

In accordance with another aspect, there is provided an apparatus for calculating homography of a Fourier propagation structure, including a memory configured to store at least one program, and a processor configured to execute the program, wherein the program is configured to perform generating a point array image, inserting a certain frame into an edge of the point array image, generating a phase hologram based on the point array image, perform optical restoration and camera capturing on the phase hologram, extracting a point array from each of an optically restored image and a camera-captured image, and calculating homography based on the extracted point array.

The program may be configured to, in generating the phase hologram, generate the phase hologram in a partial region of a total area represented by Fourier propagation.

The program may be configured to further perform removing a region in which interference occurs from the certain frame.

The program may be configured to further perform linearly correcting brightness of the point array image.

The program may be configured to perform, in linearly correcting the brightness, generating a scaling factor image having a value within a preset range, and multiplying the point array image by the generated scaling factor image.

The value within the preset range may be a value ranging from ‘0’ to ‘1’.

In accordance with a further aspect, there is provided a method for calculating homography of a Fourier propagation structure, including generating a point array image, linearly correcting brightness of the point array image, generating a phase hologram based on the point array image, perform optical restoration and camera capturing on the phase hologram, extracting a point array from each of an optically restored image and a camera-captured image, and calculating homography based on the extracted point array.

Generating the phase hologram may include generating the phase hologram in a partial region of a total area represented by Fourier propagation.

The method may further include inserting a certain frame into an edge of the point array image, and removing a region in which interference occurs from the certain frame.

Linearly correcting the brightness may include generating a scaling factor image having a value within a preset range, and multiplying the point array image by the generated scaling factor image.

The value within the preset range may be a value ranging from ‘0’ to ‘1’.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a Fourier propagation optical structure;

FIG. 2 is a diagram illustrating a Fourier propagation optical structure to which an embodiment is applied;

FIG. 3 is a diagram illustrating an example of a target plane image in a Fourier propagation optical structure to which an embodiment is applied;

FIG. 4 is a diagram illustrating an example of an optically restored image in a Fourier propagation optical structure to which an embodiment is applied;

FIG. 5 is a flowchart for explaining a method for calculating homography of a Fourier propagation structure according to an embodiment;

FIG. 6 is a diagram illustrating an example of a point array;

FIG. 7 is a diagram illustrating an example of optical restoration or camera capturing of a point array;

FIG. 8 is a diagram illustrating an example of a point array image into which a frame is inserted according to an embodiment;

FIG. 9 is a diagram illustrating an example of point array phase hologram observation illustrated in FIG. 8;

FIG. 10 is a diagram illustrating an example of a point array image in which an interference region is removed from a frame according to an embodiment;

FIG. 11 is a diagram illustrating an example of point array phase hologram observation illustrated in FIG. 10;

FIG. 12 is a diagram illustrating an example of a scaling factor image according to an embodiment;

FIG. 13 is a diagram illustrating an example of a point array image, the brightness of which is corrected, according to an embodiment;

FIG. 14 is a diagram illustrating an example of point array phase hologram observation illustrated in FIG. 13; and

FIG. 15 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

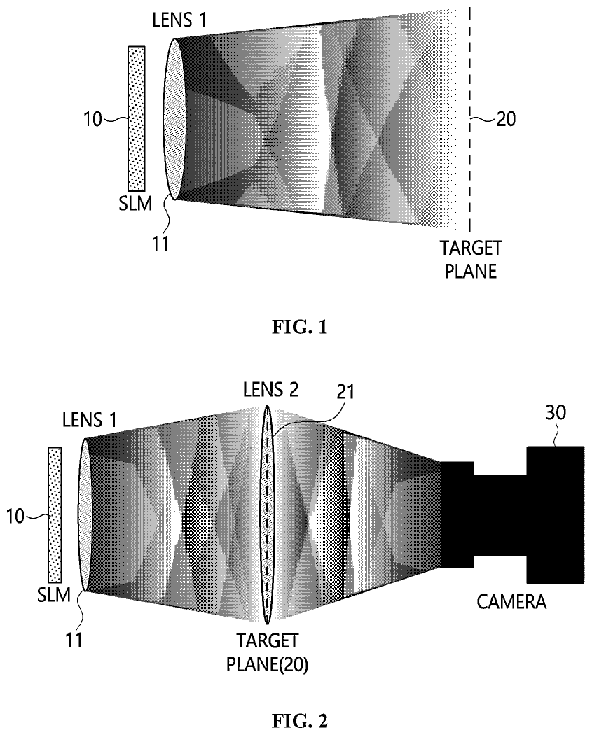

FIG. 1 is a diagram illustrating a Fourier propagation optical structure.

Referring to FIG. 1, Fourier propagation that is capable of increasing the size of an output image is used in an embodiment. That is, in Fourier propagation, a hologram plane Spatial Light Modulator (SLM) 10 and an output plane (i.e., a target plane) 20 have a Fourier Transform (FT) relationship.

FIG. 2 is a diagram illustrating a Fourier propagation optical structure to which an embodiment is applied.

Referring to FIG. 2, in an embodiment, an optical structure in which a second lens (lens2) 21 is arranged on a target plane 20 may be used so that a user can observe an image projected by a Fourier propagation structure.

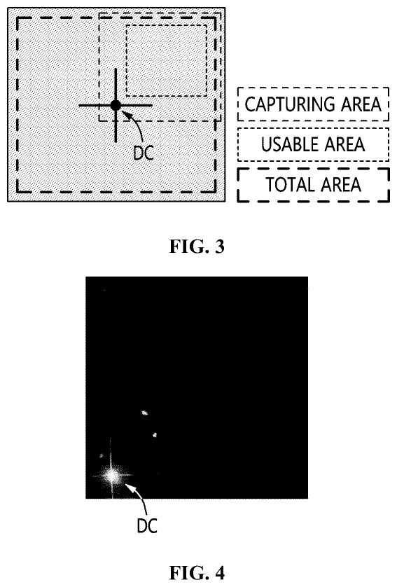

FIG. 3 is a diagram illustrating an example of a target plane image in a Fourier propagation optical structure to which an embodiment is applied.

Referring to FIG. 3, a problem arises in that a Direct Current (DC) component occurs on the target plane 20 in the Fourier propagation optical structure illustrated in FIG. 2, and a conjugate of an output image occurs symmetrically with respect to the DC component.

Therefore, in an embodiment, in order to avoid the DC component and the conjugate occurring in the Fourier propagation structure, only ¼ of the total area of the target plane is used as a usable area.

FIG. 4 is a diagram illustrating an example of an optically restored image in a Fourier propagation optical structure to which an embodiment is applied.

The optically restored image illustrated in FIG. 4 corresponds to a capturing area in the total area illustrated in FIG. 3, and refers to an optically restored image when input is ‘0’.

Therefore, according to an embodiment, for CITL-based phase hologram optimization in Fourier propagation, a phase hologram in which a point array used as a calibration pattern is indicated at the position of the usable area of FIG. 3 may be generated, and thus homography may be calculated.

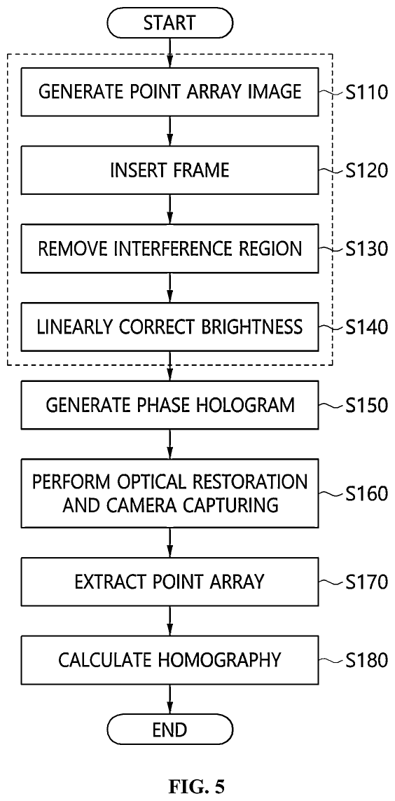

FIG. 5 is a flowchart for explaining a method for calculating homography of a Fourier propagation structure according to an embodiment.

Referring to FIG. 5, the method for calculating homography of the Fourier propagation structure according to the embodiment may include step S110 of generating a point array image, step S150 of generating a phase hologram based on the point array image, step S160 of performing optical restoration and camera capturing on the phase hologram, step S170 of extracting a point array from each of an optically restored image and a camera-captured image, and step S180 of calculating homography based on the extracted point array.

Here, at step S150 of generating the phase hologram based on the point array image, the phase hologram is generated in which a point array used as a calibration pattern is indicated at the position of the usable area of the total area illustrated in FIG. 3, as described above.

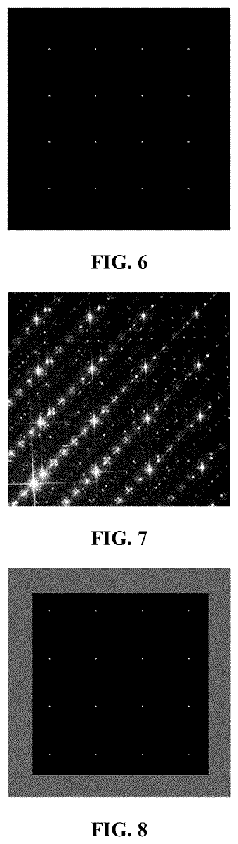

FIG. 6 is a diagram illustrating an example of a point array, and FIG. 7 is a diagram illustrating an example of optical restoration or camera capturing of a point array.

When the phase hologram is generated in which the point array illustrated in FIG. 6, used as a calibration pattern, is indicated at the position of the usable area of FIG. 3, and optical restoration and camera capturing are performed on the calibration pattern, a phenomenon such as that of FIG. 7 occurs.

Therefore, extraction of the point array fails, thus making it impossible to calculate homography and optimize a CITL-based phase hologram.

This problem is observed because, as energy is concentrated in the point array that is a region much narrower than the total area corresponding to a region that can be represented by Fourier propagation illustrated in FIG. 3, the energy of aliasing and sidelobes, occurring when each point is created, increases together with the concentrated energy.

Therefore, the method for calculating homography of the Fourier propagation structure according to the embodiment may further include step S120 of inserting a certain frame into the edge of the point array image generated at the generating step S110.

FIG. 8 is a diagram illustrating an example of a point array image into which a frame is inserted according to an embodiment, and FIG. 9 is a diagram illustrating an example of point array phase hologram observation illustrated in FIG. 8.

Referring to FIG. 8, in an embodiment, a frame having an arbitrary value is inserted into a border region of a point array image so that energy can be dispersed when a calibration pattern is created using a point array image.

When a phase hologram is generated using the point array image illustrated in FIG. 8, it may be observed as shown in FIG. 9.

Referring to FIG. 9, it can be seen that, as energy is dispersed to the frame, background noise is remarkably reduced, compared to the example of FIG. 7.

However, a conjugate of the frame within an input image occurs symmetrically with respect to a DC component, with the result that interference with a point in a lower-left portion occurs.

Therefore, the method for calculating homography of the Fourier propagation structure according to the embodiment may further include step S130 of removing an interference region in the certain frame inserted into the edge of the point array image generated at the generating step S110.

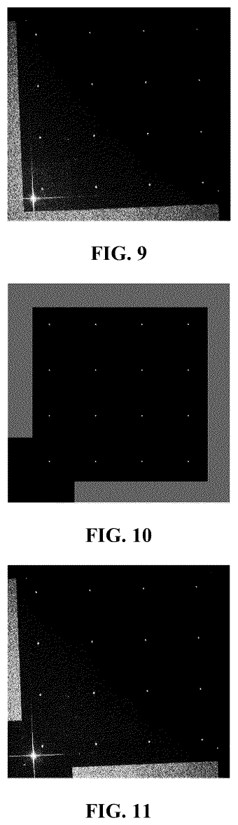

FIG. 10 is a diagram illustrating an example of a point array image in which an interference region is removed from a frame according to an embodiment, and FIG. 11 is a diagram illustrating an example of point array phase hologram observation illustrated in FIG. 10.

Referring to FIG. 10, a frame except for a region in which interference occurs may be inserted into a point array image so as to avoid a decrease in detection accuracy attributable to conjugate interference.

FIG. 11 illustrates an image that is optically restored by generating a phase hologram using the image of FIG. 9 as an input image. It can be seen that background noise is reduced around a lower-left point, compared to the image of FIG. 9.

However, through the images illustrated in FIGS. 7, 9, and 11, it can be seen that the brightness of the point array image is weakened in a direction farther away from the DC component, and the accuracy of point detection is deteriorated in a direction toward an upper-right portion.

Therefore, the method for calculating homography of the Fourier propagation structure according to the embodiment may further include step S140 of linearly correcting the brightness of the point array image generated at the generating step S110.

Here, the brightness may be linearly corrected by multiplying a scaling factor image having a value within a preset range by the point array image.

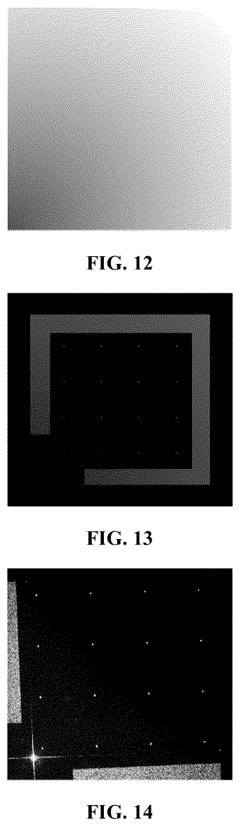

FIG. 12 is a diagram illustrating an example of a scaling factor image according to an embodiment, FIG. 13 is a diagram illustrating an example of a point array image, the brightness of which is corrected, according to an embodiment, and FIG. 14 is a diagram illustrating an example of point array phase hologram observation illustrated in FIG. 13.

In an embodiment, in order to improve the accuracy of detection in all regions, a scaling factor image having a value ranging from 0 to 1 is set, as illustrated in FIG. 12, after which the scaling factor image is multiplied by the point array image illustrated in FIG. 10, and thus the brightness of the point array image may be linearly corrected, as illustrated in FIG. 13.

Referring to FIG. 14, it can be seen that an image optically restored by generating a phase hologram using an input image is shown, and all points have similar brightness.

According to the above-described embodiment, the point array may be extracted, and uniform CITL results may be obtained.

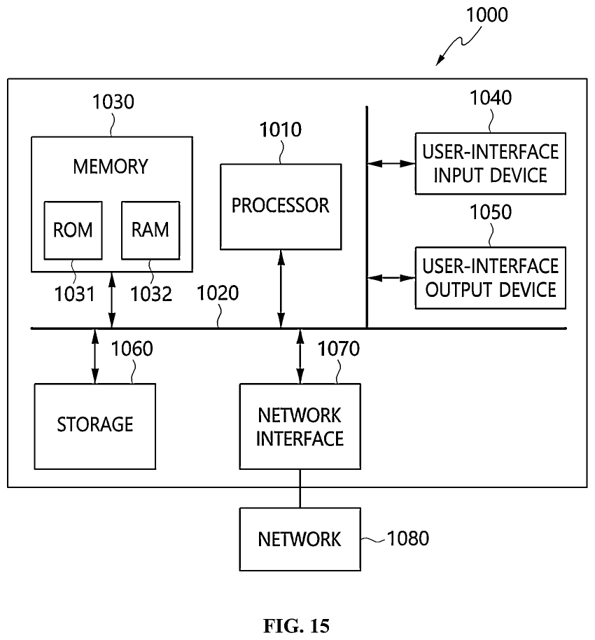

FIG. 15 is a diagram illustrating the configuration of a computer system according to an embodiment.

An apparatus for calculating homography of a Fourier propagation structure according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

According to embodiments, homography required for mapping may be calculated so as to optimize a camera-in-the-loop (CITL)-based hologram in a Fourier propagation structure.

According to embodiments, homography for accurate calibration may be calculated even when there is significant background noise occurring in a Fourier propagation structure.

According to embodiments, there is an advantage in that the reliability of the result of CITL-based hologram optimization that is performed by the result of homography calculation may be improved.

Although the embodiment of the present disclosure has been disclosed, those skilled in the art will appreciate that the present disclosure can be implemented as other concrete forms, without departing from the scope and spirit of the disclosure as disclosed in the accompanying claims. Therefore, it should be understood that the exemplary embodiment is only for illustrative purpose and do not limit the scope of the present disclosure.

What is claimed is:

1. A method for calculating homography of a Fourier propagation structure, comprising:
generating a point array image;
inserting a certain frame into an edge of the point array image;
generating a phase hologram based on the point array image;
perform optical restoration and camera capturing on the phase hologram;
extracting a point array from each of an optically restored image and a camera-captured image; and
calculating homography based on the extracted point array.

2. The method of claim 1, wherein generating the phase hologram comprises:
generating the phase hologram in a partial region of a total area represented by Fourier propagation.

3. The method of claim 1, further comprising:
removing a region in which interference occurs from the certain frame.

4. The method of claim 1, further comprising:
linearly correcting brightness of the point array image.

5. The method of claim 4, wherein linearly correcting the brightness comprises:
generating a scaling factor image having a value within a preset range; and
multiplying the point array image by the generated scaling factor image.

6. The method of claim 5, wherein the value within the preset range is a value ranging from ‘0’ to ‘1’.

7. An apparatus for calculating homography of a Fourier propagation structure, comprising:
a memory configured to store at least one program; and
a processor configured to execute the program,
wherein the program is configured to perform:
generating a point array image;
inserting a certain frame into an edge of the point array image;
generating a phase hologram based on the point array image;
perform optical restoration and camera capturing on the phase hologram;
extracting a point array from each of an optically restored image and a camera-captured image; and
calculating homography based on the extracted point array.

8. The apparatus of claim 7, wherein the program is configured to, in generating the phase hologram, generate the phase hologram in a partial region of a total area represented by Fourier propagation.

9. The apparatus of claim 7, wherein the program is configured to further perform:
removing a region in which interference occurs from the certain frame.

10. The apparatus of claim 7, wherein the program is configured to further perform:
linearly correcting brightness of the point array image.

11. The apparatus of claim 10, wherein the program is configured to perform:
in linearly correcting the brightness,
generating a scaling factor image having a value within a preset range; and
multiplying the point array image by the generated scaling factor image.

12. The apparatus of claim 11, wherein the value within the preset range is a value ranging from ‘0’ to ‘1’.

13. A method for calculating homography of a Fourier propagation structure, comprising:
generating a point array image;
linearly correcting brightness of the point array image;
generating a phase hologram based on the point array image;
perform optical restoration and camera capturing on the phase hologram;
extracting a point array from each of an optically restored image and a camera-captured image; and
calculating homography based on the extracted point array.

14. The method of claim 13, wherein generating the phase hologram comprises:
generating the phase hologram in a partial region of a total area represented by Fourier propagation.

15. The method of claim 13, further comprising:
inserting a certain frame into an edge of the point array image; and
removing a region in which interference occurs from the certain frame.

16. The method of claim 13, wherein linearly correcting the brightness comprises:
generating a scaling factor image having a value within a preset range; and
multiplying the point array image by the generated scaling factor image.

17. The method of claim 16, wherein the value within the preset range is a value ranging from ‘0’ to ‘1’.
